(19) United States
(12) Patent Application Publication
(10) Pub. No.: US 2017/0200125 A1
(43) Pub. Date: Jul. 13, 2017

(54) Information visualization method and intelligent visual analysis system based on text curriculum vitae information

(71) Applicant: INSTITUTE OF SOFTWARE, CHINESE ACADEMY OF SCIENCES, Beijing (CN)

(72) Inventors: Hao Wang, Beijing (CN); Chen Zhang, Beijing (CN); Fanjiang Xu, Beijing (CN); Wei Wang, Beijing (CN)

(21) Appl. No.: 14/898,897

(22) PCT Filed: Oct. 15, 2014
(86) PCT No.: PCT/CN2014/088601

§ 371 Date: Dec. 16, 2015

(30) Foreign Application Priority Data
Sep. 25, 2014 (CN) 201410496047.1

(51) Int. Cl. G06Q 10/10; G06F 17/21; G06F 17/27

(52) U.S. Cl. CPC G06Q 10/1053; G06F 17/2705; G06F 17/278; G06F 17/211; G06F 17/2735

(57) ABSTRACT

The present invention discloses an information visualization method and an intelligent visual analytics system for visualizing information in text resume. The method includes: 1) conducting quantitative calculation on experience data for each text resume to obtain a growth trajectory sequence and visualizing such sequence; 2) selecting the growth trajectory sequence from multiple resumes to conduct associative analysis to obtain potential social relationships between resumes, and creating visualization for a latent social network; 3) based on the potential social relationships, converting personnel overlapping in a common work place into an organization hierarchy, and visualizing such organization hierarchy. The present invention uses data mining and information visualization techniques to obtain a person's temporal growth experience, to identify potential social relations among people, and to reconstruct the organization hierarchy of personnel, which achieves deeper understanding of personnel growth patterns and social relationships.

### TECHNICAL FIELD

The present invention relates to the field of computer technology, and in particular, to an intelligent visual analytics system and an information visualization method for visualizing information in text resume.

### BACKGROUND OF THE INVENTION

Resume (or curriculum vitae) is a summary of a personal's experiences; it is based on a person's historic data, including the basic personal information and a brief description of personal experience data. Basic personal information can include name, gender, date of birth, nationality, education level, political affiliation, religion, family members, major social relations, marriage and personal health status, etc. As an important part of resume, personal experience usually includes person's education experiences, work experiences, and so on.

Biographical data is an important basis for personnel evaluation, which in many ways reflects the individual's past behaviors and current capabilities. Resume analysis uses personnel's past behaviors reflected in the biographical data to predict future behavior, which is widely used in various enterprises and institutions for personnel selection and recruitment, in government institutions for assessment and management of the officials, as well as talent evaluation and assignment of scientific and technological research personnel.

With the continuous development of information technology, data for electronic resume has grown and spread explosively in recent years. Electronic resumes come from two main sources: \textcircled{1} resumes published on the Internet; \textcircled{2} non-public resumes stored at the human resource departments in enterprises and institutions. Furthermore, electronic resumes can be categorized as structured and unstructured types: \textcircled{1} structured resumes: usually in table form, used in internal management system in the human resource departments in enterprises and institutions. They have standardized and fixed structures, and can be easily managed. However, the structured resumes have fixed structures and are not easily extended, and it is difficult to conduct deep semantic analysis. \textcircled{2} unstructured resumes: usually in text form. They originate from diverse sources, such as major Internet news sites or social media. Unstructured resumes have varied structures, and are not easily analyzed or managed. However, because they use text form as carrier, they often contain rich semantic information which can be used for intelligent semantic analysis such as semantic search and classifications.

Meanwhile, with the increasing amount of biographical data, the traditional manual analysis methods have low efficiency, and are inadequate to process a large amount of biographical data. Therefore, curriculum vitae analysis system (CVAS) has been developed based on computer processing power. CVAS is mainly used for automated analysis and management for structured biographical data. It utilizes the powerful processing and analysis power of computers to quickly filter out curriculum vitae that do not meet the requirements based on biographical data, thus greatly improving efficiency of biographical analysis. Moreover, it can also conduct quantitative analysis of log data and scientific assessments according to specific application requirements, which makes biographical analysis more suitable and reliable. Therefore, in recent years, CVAS personnel management has attracted attention by more and more enterprises and institutions, and has been widely used in personnel promotion and other human resource management activities.

In summary, the biographical analysis has been transformed from traditional initial manual analysis techniques to computer automatic analysis technologies in the Internet age. In particular, CVAS has emerged in recent years; it utilizes computer processing power to greatly improve the efficiency of the biographical analysis, and has been widely applied in various fields.

However, CVAS still has following deficiencies: (1) the current CVAS system is not suitable for biographical analysis of unstructured data. Unstructured resumes are usually stored in plain text (e.g. txt, word, pdf, etc. format) and do not have uniform format and their formats can vary widely, which are difficult to be directly used by the current CVAS. In other words, the current CVAS lacks capability of converting unstructured resume into structured curriculum vitae. (2) The analysis capability of the current CVAS system is mainly reflected in the simple rule-based qualitative analysis and quantitative calculation (such as resume screening and scoring) and statistical management (such as generating resume reports), while ignoring intelligent mining the potential pattern inherent to resumes and intuitive visual analysis, especially ignoring extracting the mode of personal growth from the resumes as well as intuitive visualization of such growth patterns, which cannot help the user to complete complex tasks, such as semantic based search and classification, personnel recommendations, and career planning. (3) The CVAS current system also analyzes resumes individually while ignoring the resumes. Potential association between resumes may reflect underlying social relationships among people. Such relationships may be based on overlapping experiences such as students, colleagues, fellow comrades, partners, competitors and other relations. These relationships can be used to build social network among people. Such a social network may be useful for resume management, grasping potential social relevance between personnel, and discovering and achieving deeper understanding of organizational hierarchical relationship between personnel.

### SUMMARY OF THE INVENTION

The present invention is developed to overcome the above described drawbacks in conventional methods and systems, to provide an intelligent visual analytics system and an information visualization method for visualizing information in text resume. The presently disclosed methods take full advantage of the potential pattern in biographical data, to construct a visual analytics environment for resumes using natural language processing, data mining, machine learning, and information visualization technologies. The presently disclosed methods can help users understand the potential personal growth patterns and correlation between resumes, and can support semantic based search and classification, personnel recommendations, career planning, and grasping potential social relevance between personnel, etc. The present technique is based on a common framework, aiming at discovering the biographical data inherent in the potential growth patterns and potential social relationships between people. Features of these models and social relations are expressed in an intuitive and visual way. The disclosed method and system can be widely applied to intelligent mining and information visualization of staff resumes, officials' resumes, corporate executives and researchers' resumes.

Technical solution of the present invention relates to an intelligent resume visual analytics system, comprising: a text resume preprocessing module; a personal growth experience quantization module, a personal growth mode discovery module, a social relationship discovery module, an organizations construction module, and a biographical information visualization module.

The text resume pre-processing module converts an unstructured text resume to a structured text resume, by filtering format of the unstructured text resume to obtain a pure text version of the unstructured text resume; parsing words and identifying proper names in the pure text version of the unstructured text resume; extracting biographical elements from the pure text version of the unstructured text resume (from basic information and experience information table) to obtain structured text blocks comprising the biographical elements; and formatting the structured text blocks comprising the biographical elements to obtain a structured text resume (e.g. in XML data format, providing a data for the discovery and visualization by the subsequent modules).

The personal growth experience quantization module quantifies experiences in a text resume to obtain growth trajectory sequence data. This module uses natural language processing technology to quantify job function ranks in the experiences to provide basis for the subsequent discovery and visualization modules.

The personal growth pattern mining module uses machine learning and data mining technology to analyze the growth trajectory data sequence in temporal and spatial dimensions to obtain temporal growth modes and spatial growth modes.

The social relationship discovery module uses association algorithm in data mining to conduct associative computation between their associated growth trajectory sequence data to obtain potential social relationships between the text resumes (e.g. classmates, coworkers, fellow countrymen, comrades, collaborators, competitors, etc.).

The organizations construction module identifies a common organization in experiences in text resumes, and constructs organization hierarchy for the organization based on the potential social relationships in the text resumes.

The biographical information visualization module is based on the disclosed biographical information visualization method for text resumes to provide visual metaphors. The biographical information visualization module can render intuitive visualizations of the growth trajectory sequence data, the social network based on the potential social relationships, and the organization hierarchy for the organization. The visual diagrams generated help users to quickly grasp underlying knowledge and features in the biographic data.

The disclosed biographical information visualization method for text resumes can include the following:

1. Temporal spatial trajectory visualization algorithm. The algorithm is based on growth metaphors and intuitively visually expresses temporal and spatial growth trajectories of the originally abstract personal growth data.

2. Social network visualization algorithm. The algorithm is based on the potential social relationships between resumes, to construct visual expression for a social network in intuitive network diagrams.

3. Organizational hierarchy visualization algorithms. The algorithm is based on the organizational level of potential social relationships between resumes, and reconstructs the organization hierarchy for visualization. The algorithm extracts potential social relationships from resumes and identifies intersections in organizations between resumes to visually express an organization chart for the organization.

Compared with the conventional technologies, the present invention can include the following benefits:

1. In contrast to traditional methods, the presently disclosed method can process unstructured text resumes, and use natural language processing technology to extract resume elements to build structured resumes for uniform processing of resumes having different structures and formats, which greatly increases the applicable scope.

2. Compared to traditional methods, the presently disclosed method is focused on intelligently discovering potential underlying modes in the biographic data, and deeper level visual analytics of the mode information. The disclosed method can obtain growth trajectories and growth modes. Therefore it can support deep analysis tasks such as semantic-based search and classification, personnel assessment, and appointment recommendations.

3. Compared to traditional methods, the presently disclosed method innovatively introduces potential associations into biographical analysis, using data mining and information visualization technologies to expose potential social relationships between people associated with the resumes. Based on this potential relationship, a latent social network can be built. The social network is constructed based on the relationships. An organizational hierarchy can also be reconstructed using the reporting relationships between staff in the social network. Thus characters embodied in a large number of resumes can be macroscopically presented to users, which help them to achieve deeper level knowledge about social relationships in a community.

### BRIEF DESCRIPTION OF THE DRAWINGS

FIG. 1 is a flow diagram in accordance with the present invention.

FIG. 2 is a system architecture diagram in accordance with the present invention.

FIGS. 3A-3D are exemplified temporal trajectory plots for personal career growths. FIG. 3A, a fast growth trajectory; 3B, a steady growth trajectory; 3C, a fluctuating growth trajectory; and 3D, a declining growth trajectory. Each solid line represents a personal growth trajectory, and a dashed a trajectory for the average of the overall sample.

FIGS. 4A-4D are exemplified spatial trajectory plots for personal career growths. FIG. 4A, a growth trajectory from local government to central government; 4B, a growth trajectory from local government to central government then to local government; 4C a growth trajectory from central government then to local government; and 4D, a growth trajectory from central government to different local governments then to central government.

FIG. 5 is a schematic diagram of personal growth trajectory based on ranking classification of the positions held by a person.

FIGS. 6A and 6B are schematic diagrams for potential relationships in a group: 6A: a relationship diagram for a growth trajectory; and 6B: a relationship diagram based on overlapping experiences.

FIGS. 7A and 7B show personal growth diagrams: 7A: temporal personal growth trajectory; and 7B: spatial personal growth trajectory.

FIG. 8 is a diagram for potential relationships.

FIG. 9 is an organization chart.

FIG. 10 is a schematic diagram for statistical analysis of biographical data.

FIGS. 11A and 11B are schematic diagrams illustrating correlations in time (11A) and in space (11B), wherein the dashed frame in FIG. 11A corresponds to the area pointed by the dashed arrow in FIG. 11B.

FIG. 12 is a schematic diagram illustrating temporal career growth trajectories for visual analytics. The figure shows personal growth periods such as “rapid growth”, “bottleneck”, and “breakthrough”. Using officials' promotion as examples, “rapid growth” represents fast promotions in early career; “bottleneck” for a bottleneck encountered in mid-career with slower promotion; “breakthrough” indicates continued promotion breaking through the bottleneck at the end of career.

FIGS. 13A-13C are schematic diagrams for social network based on biographical data suitable for interactive visual analytics: the dashed frame in FIG. 13A corresponds to the spatial locus in the dashed frame in FIG. 13B, with biographical intersections with others shown in a social network diagram in FIG. 13C.

### DETAILED DESCRIPTION OF THE INVENTION

In order to make the purpose of the present invention, technical solutions and advantages of the invention more apparent, the following examples are provided to describe the present invention in detail.

### Definitions of Terms

Personnel: history represented body, such as employees of enterprises and institutions, government department-level officials, corporate executives and research staff.

User: system users, typically decision makers, such as leaders and management staff of enterprises and institutions.

Resume: resumes or curriculum vitae of officers in government departments, staff in enterprises and institutions, business executives, researchers, and entertainment celebrities, etc.

The present invention relates to concepts, methods, and systems as common framework, which can be applied to analysis tasks of different types of biographical data. For the ease of description, resumes of government officials are used as examples to illustrate the present invention.

The present invention is based on natural language processing, data mining, machine learning, and information visualization technologies. The presently disclosed method and system construct visual analytics environment for biographical data, to take full advantage of the information in text resumes, to extract knowledge from the biographical data that may potentially play important role in decision-making, to visually demonstrate intuitive growth metaphoric patterns based on the knowledge, which enables tasks such as fuzzy search and intelligent classification, automated personnel appointment and removal, career planning, and personal relationship development.

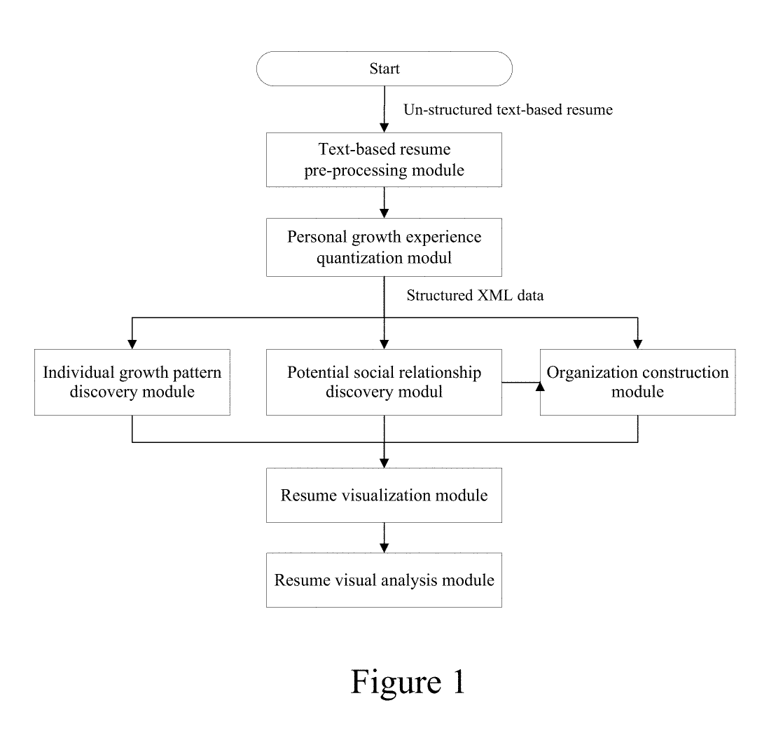

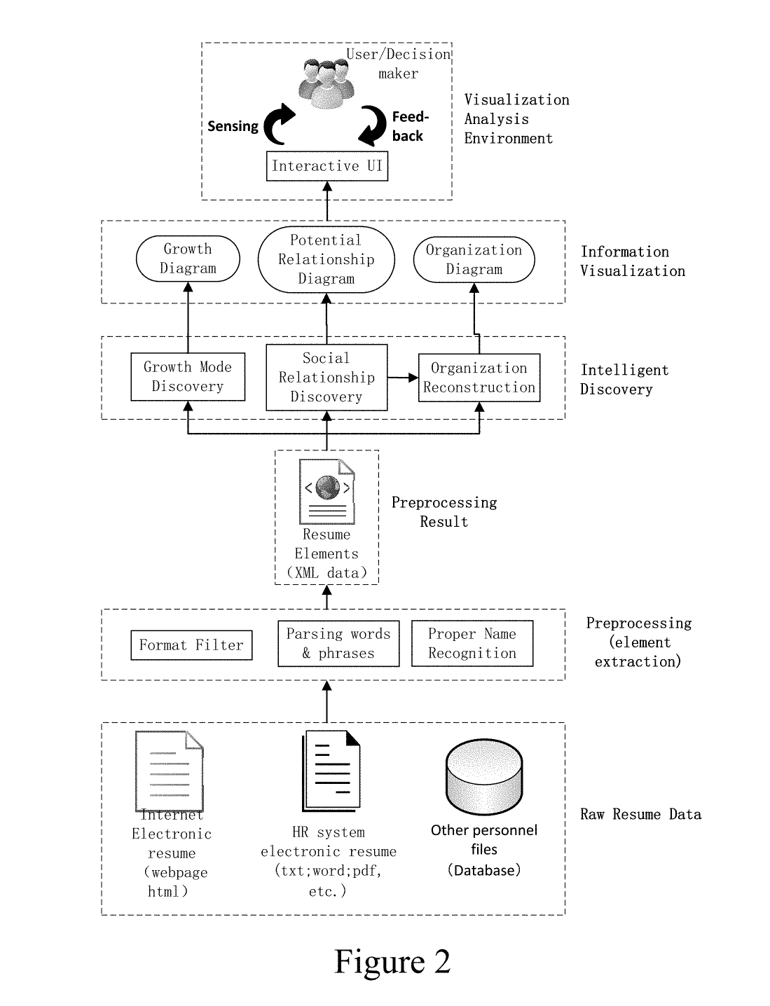

As shown in FIG. 1, the process in accordance to the present invention can include a text resume pre-processing module, a personal growth experience quantization module, an individual growth mode discovery module, a social relationship discovery module, an organization construction module, a biographical information visualization module, and a resume visual analytics module. A system architecture of the present invention is shown in FIG. 2, among them:

1. Text Resume Preprocessing Module

This module conducts preprocessing of the unstructured text data in the resume. Some natural language processing techniques, such as format filter, Chinese Word Segmentation and named entity recognition, are performed to obtain structured XML resume element data (eXtensible Markup Language).

The XML data format is tailored designed to capture characteristics of biographical data. The XML data has hierarchical structure, as shown below:

```
  <? xml version = “1.0” encoding = “UTF-8”?>
− <official_store version = “1.0”>
    − <Official category = “reserved”>
        + <Basic_info>
      − <office_record_array>
          + <office_record>
          + <office_record>
        ......
        </office_record_array>
    </official>
    </official_store>
```

As shown above, the XML data contains two sections of biographical elements: basic biographical information and experience information table. The basic biographical information includes name, sex, nationality, place of birth, and other basic information. The experience information is formatted in a table structure: the table header contains the start time, end time, location, organization, position, and other fields. Each entry in the table records one of the person's experiences, namely, the person's experience (work or education) within a certain time.

Unstructured text biographical data mainly include text resume (html format) from the Internet, text resume from the human resource systems (in file formats such as txt, word, pdf, etc.), and other personnel files (stored in the database). The text resume from the Internet is shown as follows. Their data can be usually obtained by a Web crawler from the Internet. These resumes are complex to preprocess because their formats are complex and not uniform.

<title>
Zhang resume_personnel library _Xinhua
</title>
<body>
<basic_info>

Zhang San, male, Han nationality, born Aug. 2, 1975, Changsha, Hunan. Started working in January 1990; joined party in December 1991; currently governor of Hunan Province.

</basic_info>
<record>
1989-1992 Ningxiang County in Hunan Province Health Bureau branch
secretary.
1992-1995 Ningxiang county party secretary.
1995-1998 Deputy Mayor of Changsha City, Hunan Province.
1998-2002 Changsha City, Hunan Province party secretary.
2002-2010 Vice Governor of Hunan Province.
2010-present Governor of Hunan Province.
</record>
Please click here for other people's experience
Weather forecast - International News - Domestic News
</body>

The module can perform the following specific steps:

1) Using html parsing algorithm to eliminate “noise” such as advertisement and html from the original biographical text, to obtain clean text containing biographical information. The clean text biographical data is shown below. The data consists of two text segments: basic information and experiences. This step is aimed mainly at resumes originated from the Internet.

Zhang San, male, Han nationality, born Aug. 2, 1975, Changsha, Hunan. Started working in January 1990; joined party in December 1991; currently governor of Hunan Province.

1989-1992 Ningxiang County in Hunan Province Health Bureau branch secretary.

1992-1995 Hunan Ningxiang County council secretary.

1995-1998 Deputy Mayor of Changsha City, Hunan Province.

1998-2002 Changsha City, Hunan Province council secretary.

2002-2010 Vice Governor of Hunan Province.

2010-present Governor of Hunan Province.

2) The plain text resume is processed using natural language processing technology to parse words and phrases, and to recognize proper names (named person or entities). Biographical feature elements are extracted using a feature extraction algorithm from the unstructured biographical text data and processed to obtain structured text containing the biographical feature elements. The structured text blocks, shown as follows, include basic information and experience information, wherein “/NAME”, “/TIME”, “/TITLE” and other structure identifiers represent “name”, “time”, “duty”, and other biographic feature elements.

Zhang San/NAME M/GENDER Han/NATION 1975.8.2/BIRTHDATE Changsha Hunan/BIRTHPLACE 1990.1.1/WORKTIME 1991.12.1/PARTYTIME governor of Hunan Province/CURRENTTITLE
{1989-1992}/TIME Ningxiang County Hunan Province/POS health bureau branch/ORG secretary/TITLE
{1992-1995}/TIME Ningxiang County Hunan Province/POS county council/ORG secretary/TITLE
{1995-1998} Deputy Mayor/TIME Changsha City, Hunan Province/POS city council/ORG deputy major/TITLE
{1998-2002}/TIME Changsha City, Hunan Province/POS city council/ORG secretary/TITLE
{2002-2010}/TIME Hunan/POS province council/ORG Vice Governor/TITLE
{2010-2014}/TIME Hunan/POS province council/ORG governor/TITLE

3) The structured text blocks comprising the biographical elements are converted into a predetermined format, according to the hierarchical structure below, to form structured XML biographical data elements. The hierarchical structure organizes the biographical elements into basic information section (basic_info) and experience information section (office_record_array). The basic information section holds the basic biographical information, structured in a fixed list format. The experience information section is designed in a tree structure, with tree node representing different periods of experiences (office_record). The tree structure has a good scalability, and can easily and quickly be expanded and inquired. This structure can significantly improve the computation efficiency for large-scale biographical feature elements.

The following is an example of complete XML data:

```
<? Xml version = “1.0” encoding = “UTF-8”?>
<Official_store version = “1.0”>
  <Official category = “reserved”>
    <Basic_info>
      <Name> personnel </name>
      <Nation> Han </nation>
      <Birth_place> Changsha </birth_place>
      <Age> 39 </age>
      <Gender> M </gender>
      <Date category = “birth”>
        <Year> 1975 </year>
        <Month> 8 </month>
        <Day> 2 </day>
      </Date>
      <Date category = “party”>
        <Year> 1991 </year>
        <Month> 12 </month>
        <Day> 1 </day>
      </Date>
      <Date category = “work”>
        <Year> 1990 </year>
        <Month> 1 </month>
        <Day> 1 </day>
      </Date>
    </Basic_info>
    <Office_record_array>
      <Office_record>
        <Date category = “start”>
          <Year> 1989 </year>
          <Month> 1 </month>
          <Day> 1 </day>
        </Date>
        <Date category = “end”>
        <Year> 1992 </year>
          <Month> 1 </month>
          <Day> 1 </day>
        </Date>
        <Tuple_array>
          <Tuple>
          <Organization> Ningxiang County in Hunan Health Bureau
branch </Organization>
                  <location>
                  <province> Hunan </province>
                  <city> Changsha </city>
            </location>
            <post_array>
              <post_entity>
                <post_name> secretary </post_name>
                <rank> 0 </rank>
              </post_entity>
            </post_array>
          </tuple>
        </tuple_array>
      </office_record>
    </office_record_array>
  </official>
</official_store>
```

Among the above, the feature extraction algorithm in step 2 is a core algorithm module, which mainly extracts various feature elements by matching regular expressions. The method can specifically include the steps of:

2-1) extraction of basic information: the regular matching method is used to extract given name, family name, birth place, and date of birth, work date, party date, and other information.

2-2) extraction of experience information:

\textcircled{1} The “time” and “place” elements are extracted using the regular matching method. For example, the “year” is used as a regular match keyword to extract “time” elements. “Province”, “city”, “county”, and “xiang” are used a regular feature matching keyword to extract “place” elements.

\textcircled{2} For the “organization” elements, the extractions are based on keyword matching using a predesigned organization keyword dictionary (Table 1). Each row element in the keyword dictionary organization consists of two parts: “keyword” and “auxiliary keyword”, wherein the “auxiliary keyword” includes two R-type and L-type; and multiple “auxiliary keywords” are separated by commas. The principle of using organization keywords in the organization keyword dictionary to identify organization elements is as follows: when a keyword in the organization keyword dictionary is recognized, if its right side does not include an R-type “auxiliary keyword” and its left side does not include a L-type “auxiliary keyword”, then the recognition is considered successful; otherwise, the recognition is failed.

TABLE 1
Organization keyword dictionary

Auxiliary keyword

| Keywords | R type | L type |
|---|---|---|
| Lab | Zhang | |
| College | Zhang | |
| Institute | Zhang | |
| Ministry | Zhang, Dui | Gan |
| Department | Zhang, Yuan, Ji, Xue, Xie, Gong | |
| Team | Zhang | |
| . . . | . . . | . . . |

For example, the element on line 4 in Table 1 represents the keyword “Ministry” (i.e. “Bu” in Chinese). Its R-type “auxiliary keywords” include “Zhang” and “Dui”, and its L-type “auxiliary keyword” includes “Gan”. In the recognition step, when “Zhang” and “Dui” do not appear on the right side of the “Ministry” character, and “Gan” not on its left side, the organization element recognition is considered successful. In other words, phrases like “BuDui”, “BuZhang” and “GanBu” should not appear as organization elements.

\hat{3} The “duty” element is obtained by regular matching after extracting the text segment of the “organization” elements.

2. The Personal Growth Experience Quantization Module

This module obtains sequence data for the growth trajectory from XML biographical element data. As shown in Table 2, the sequence data can include six element groups, namely, <start time, end time, location, organization, functions, quantized rank>, wherein the last field “quantized rank” to characterize the ranking level for the job experience.

TABLE 2
Growth Path Sequence Data Sheet

| Start | End | | | | Quantized |
|---|---|---|---|---|---|
| time | time | Location | Organization | Post | rank |
| 1989 | 1992 | Ningxiang | Branch Health | Secretary | 0 |
| | | County in Hunan | Bureau | | |
| 1992 | 1995 | Ningxiang | County Council | Secretary | 2 |
| | | County in Hunan | | | |
| 1995 | 1998 | Changsha, Hunan | City Council | Vice- | 3 |
| | | | | mayor | |
| 1995 | 2002 | Changsha, Hunan | City Council | Secretary | 4 |
| 2002 | 2010 | Hunan Province | Province | Vice | 5 |
| | | | Council | Governor | |
| 2010 | 2014 | Beijing | City Council | Mayor | 6 |

The core algorithm of this module relates to quantized rank recognition. The method specifically includes the steps of:

1) Sequencing the experiences in each experience table of the biographical information in ascending order based on the “Start Time” field, to obtain experience tables in chronological order.

2) Scanning each record in the chronologically ordered experience table. Extracting from each record in “place”, “organization”, and “title” fields, and the value of each field, and compare them with the existing ranks in the rank quantization library (as shown in Table 3). The matching entities are assigned certain ranking values with numerical values representing levels of the positions. For example: 0 for entry level official, 1 for section-level official, 2 office-level official . . . , 5 representatives of national-level official.

3) Repeat step 2 until the chronologically ordered experience table is completely scanned and processed. The experience section now contains a collection of experiences having different ranks in chronological order, which provides the sequence data for a growth trajectory (Table 2).

TABLE 3
Rank Quantization Library

| | | Quantized |
|---|---|---|
| Organization | Job Function | ranks |
| Inner Mongolia Autonomous Region | Entry-level job | 0 |
| Erwenkeqi Wulanmuqi | | |
| Beijing Daily, Commerce and Industry | Deputy director | 1 |
| Department | | |
| Beijing Daily, Finance and Trade | Director | 2 |
| Department | | |
| Beijing Daily | Deputy Editor | 3 |
| Beijing Municipal Publicity Department | Deputy Minister | 4 |
| Inner Mongolia Autonomous Region | Standing | 5 |
| Committee | Committee | |
| Central Publicity Department | Deputy Minister | 6 |
| Supreme People's Disciplinary & | Secretary | 7 |
| Prosecution Committee | | |
| Politburo | Standing | 8 |
| | Committee | |
| . . . | . . . | . . . |

Wherein, the experience level quantization library mentioned step 2 is shown in Table 3. The quantization library has a dictionary structure, including three dictionary elements <organization, position, quantized rank>. The dictionary serves as the base module for quantifying personal growth experience, which is constructed by human-computer interactions:

2-1) The “organizations” and “position” fields are extracted from biographical corpus by the text resume pre-processing module. Users can also add and modify on their own.

2-2) For the “quantized rank” field, an initial quantization value is first calculated by computer based on predetermined rank quantization rules. Then the user can adjust according to their knowledge, experiences, and special circumstances (see below for explanation of special circumstances) for processing, to ensure the accuracy of the quantized rank values.

Among them, the level of rank quantization rules mentioned step 2-2 can depend on the specific scenarios of the application:

\textcircled{1} Using the resumes of the government officials as example, the administrative levels for officials in China are classified as follows: national level (quantified to 5), provincial level (quantified to 4), the bureau level (quantified to 3), county level (quantified to 2), township branch level (quantified to 1), and other levels, where each level can be further subdivided to regular and deputy positions.

\textcircled{2} In the example of “resumes” for researchers in research institutions, titles for researchers can be quantified as follows: academy member (quantized to 5), research fellow (quantized to 4), associate research fellow (quantized to 3), assistant researcher (quantized to 2), intern researcher (quantized to 1), and other levels.

While rank quantization rules can generally result in correct quantized ranks, there remains some special circumstances that require manual adjustment. For example: a computer can quantize the level to “XX mayor” in the position field to be at secretary bureau level (level 3), which may be correct in most situations. However, if the job field is “the mayor of Beijing”, “Mayor of Shanghai”, and other municipality mayors, the corresponding quantized rank should be assigned to the ministry level (level 4).

3. Personal Growth Patterns Mining Module

The growth pattern classification algorithm in this module innovatively applies supervised machine learning classification algorithms (such as Naive Bayesian, SVM (Support Vector Machine) algorithm) as well as sequential pattern mining algorithm, thereby automatically classifying unknown biographical data based on the growth patterns of known biographical data. This module and its algorithms can help users quickly grasp the growth type of the associated resumes and predict future trends based on the growth model. The method can specifically include the steps of:

1) Defining types of personal growth trajectory.

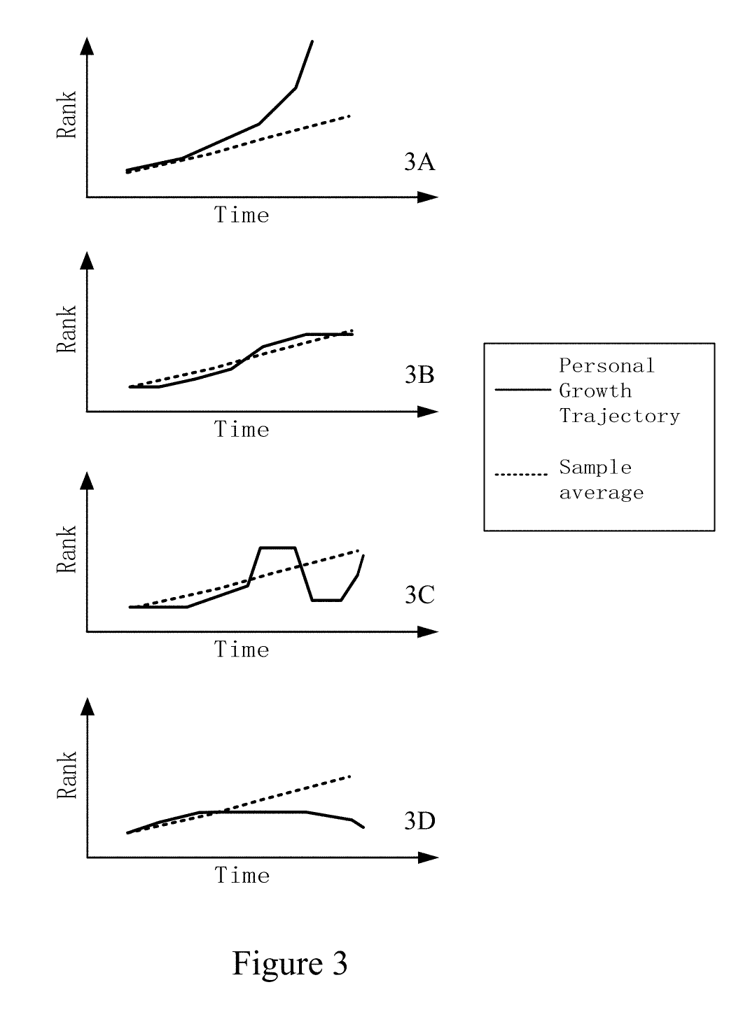

\textcircled{1} The time dimension. The growth changes over time based on the resume can be defined. Examples of growth types can include (as shown in FIGS. 3A-3D): fast growth, steady growth, fluctuating growth, and declining growth types.

The four types of growth trajectories (solid lines in FIGS. 3A-3D) are defined with respect to the average of the overall sample (see FIGS. 3A-3D in dashed lines). The time span of experience spent at each job rank can be measured for each individual growth trajectory to obtain individual person's career growth rate (the slopes of the curves in FIGS. 3A-3D). The growth rate of fast growth type is significantly greater than the sample average over the entire time dimension. The steady growth has growth rate about the equal to the sample average. The growth rate of the fluctuating growth type has growth rates greater than the sample average at some stages and lower than the sample average at some other stages. The declining growth type has significantly lower growth rate than the sample average over the entire time dimension.

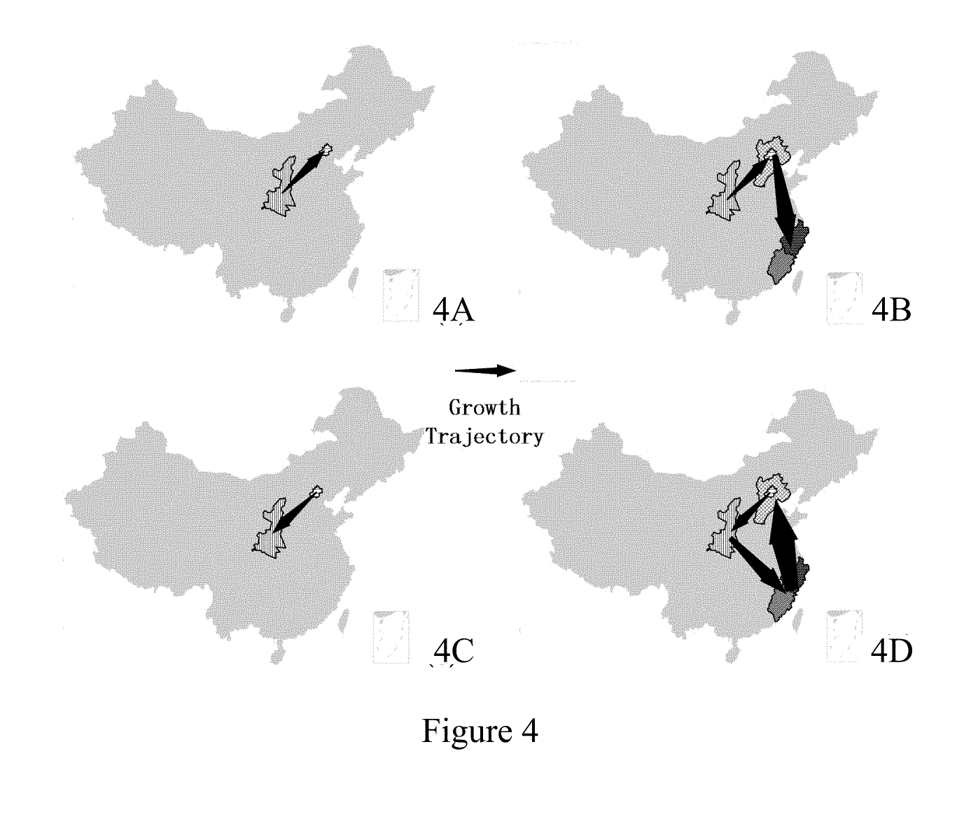

\textcircled{2} The spatial dimensions. The type of career growth can be defined by migrations in space, such as the four growth types shown in FIGS. 4A-4D (also called “sequence mode” in the context of data mining): from “local government to central government”; “from local government to central government then to local government”; “from central government to local government”; and “from central government to local government(s) then to central government”, wherein “central” indicates Beijing, and “local” represents other cities and provinces. In addition, space can be subdivided into “the southeast coast”, “western region”, “remote mountainous areas”, and other smaller spatial regions. It should be noted that the above types only cover several types of characteristic spatial migrations. Without losing generality, other migrations types such as “local government to local government” or “central government then to central government” can be similarly analyzed and evaluated by the presently disclosed method.

2) Defining characteristics of the growth trajectory types. “Feature”, as defined in machine learning and data mining areas, can be used to characterize different types of growth trajectory sequence data. Machine learning/data mining algorithms can obtain data types and corresponding data mining models only through characteristic data.

\textcircled{1} Time dimension features. Based on the temporal growth types described in step 1, growth rates of the growth trajectories of the sequence data can be used to characterize the time dimension. Growth rates can be categorized in the following two types of characteristics:

a. Time span at each rank, which represents times an individual spent at different job ranks. Its formal expression is: “<quantized rank 1, time span 1>, <quantized rank 2, time span 2> . . . , <quantized rank n, time span n>”, wherein n represents the length of the sequence data (the number of data elements in the sequence) corresponding to the growth trajectory. The time span can be obtained from the difference between “End Time” and “Start Time” in the sequence data. For example, as shown in Table 2, the time series data at different ranks are characterized by: “<0, 3>, <1, 0>, <2, 3>, <3, 3>, <4, 4>, <5, 8>, <6, 4>, <7, 0>, <8, 0>”.

b. Temporal growth slope, which represents slope values of individual's growth trajectory at different time periods. Its formal expression is: “<time phase 1, slope 1>, <time stage 2, slope 2> . . . , <time stage m, slope m>”, wherein m represents the sequential number of the time period. The number is generally given by the experience, for example, m=10 means segmenting the sequence data of the growth trajectory by 10 portions along the time dimension. It should be noted that sequence data of different growth trajectories generally do not have the same time span and thus their slopes are not directly comparable. Hence the time-series data need to be normalized in time dimensions; the time span is normalized to the range of [time point 1, time point m]. For example, the sequence data in Table 2 can be divided into 10 periods: “1989.1.1˜1991.6.1”, “1991.6.1˜1994.1.1” . . . , “2011.6.1˜2014.1.1”. The slope of growth trajectory in each time period is calculated as the difference between the quantized rank at the end of time period and the quantized rank at the beginning of time period. Therefore, the series of growth slopes are: “<1, 0>, <2, 2>, <3, 1>, <4, 1>, <5, 0>, <6, 1>, <7, 0>, <8, 0>, <9, 1>, <10, 0>”.

It should be noted that the above two types of time dimension features can be used alone or in combination in machine learning.

\textcircled{2} Spatial dimension features (also referred to as “spatial sequence”). From the spatial dimension type in step 1, the geographic location of the individual work location can characterize as a spatial dimensions of the growth trajectory associated with the sequence data. The spatial feature can be formalized as: “<location type 1, location type 2 location . . . , location type k>”. The “type of place” can include “central government”, “local government”, and other location types as described in step 1. k represents the number of locations in the growth trajectory of the sequence data in the “location” field. For example, the sequence data in the space dimension is characterized as follows: “<local, central>”. It should be noted that the spatial dimensions feature is called “sequence” in the sequence mode discovery, wherein the growth type in spatial dimension in step 1 is obtained by discovering the “sequence mode” in the “sequence”.

3) Based on the growth trajectory XML sequence data (referred to as “sample data”), the temporal growth type is manually tagged in accordance with the procedures in the growth types in temporal dimension in step 1 and the spatial dimension characteristics in step 2.

4) Based on the tagged growth trajectory sequence data and the temporal growth type, machine learning classifier is used for classification training, learning to obtain classifier model parameters.

5) Based on existing growth trajectory of the sequence data, for its spatial dimension characteristics, sequential pattern mining algorithm is used to obtain the sequence of pattern mining. Here the “sequence mode” corresponds to the growth modes in the spatial dimensions in step 1. The spatial growth mode can be manually tagged.

6) For temporal growth mode of unknown biographical data, after the sequence data of its growth trajectory is obtained, its temporal dimension characteristics are extracted. The data classifiers obtained by training in step 4 are used to classify the sequence data, and calculate the temporal growth mode of the unknown biographical data.

7) For spatial growth mode of unknown biographical data, after the sequence data of its growth trajectory is obtained, its spatial dimension characteristics (i.e. spatial sequences) are extracted. The sequential pattern discovery algorithm is used to mine the sequence data and to calculate the spatial dimension growth mode of the biographical data. Among them, the specific calculation method is as follows: after an unknown type of spatial sequence of sequence mode is discovered, it is compared to the spatial sequence mode of a known type discovered in step 5:

\textcircled{1} If the same sequence mode is found, then the unknown sequence is considered to be a known sequence mode type;

\textcircled{2} If none is found, it is then assumed that the sequence mode is a spatial sequence that has not appeared in the sample sequence data, which can be used to manually define a new type of spatial grow mode, and can be used in future classification of biographical data.

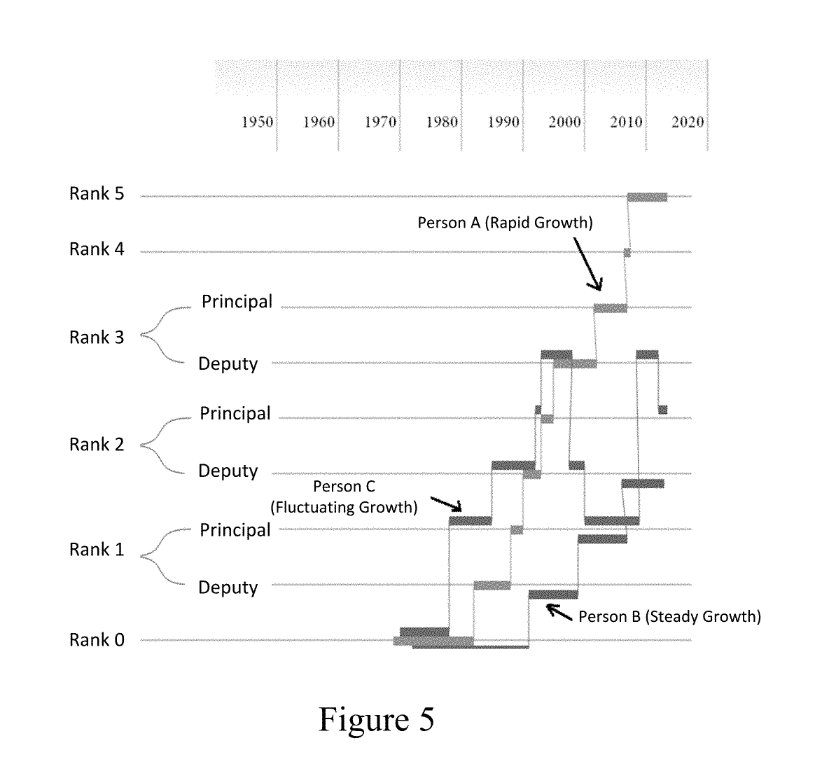

FIG. 5 is a schematic classification, wherein person A is in a rapid growth mode; person B in a steady growth mode; and person C in a fluctuating growth mode.

8) The future growth trend is predicted for a person based on the person's biographical growth type and the current job rank. For example, if computation determines that a person is in a rapid growth mode, the person's future growth rate is likely to be greater than sample average. In addition, his future job rank (for example, 10 years later) can be predicted based on his current level of job rank.

4. The Potential Social Relationship Discovery Module

The social relationships discovery algorithms in this module innovatively applies algorithms for measuring distances in growth trajectories and association rules to discover potential social relationships R (e.g. students, colleagues, fellow comrades, partners, competitors and other relations) in biographic data. The method can specifically include the steps of:

1) For a given resume library M, M size is denoted as n, which is the number of resumes. M includes elements M1˜Mn representing the resumes in resume element XML data.

2) In the resume library M, the similarity between growth modes of each pair of resume elements Mi and Mj is calculated using cosine similarity measure algorithm to obtain similarity matrix sim(i, j).

3) In the resume library M, the matching degree mch(i,j) between each pair of resume elements Mi and Mj in M is obtained using a resume element matching algorithm, to obtain matching matrix mch.

4) Scanning sim, if sim(i, j)>s0, wherein s0 is the similarity threshold, Mi and Mj are then considered to have similar growth trajectories. Larger sim(i, j) indicates more similarity between the two resumes. In other words, sim(i, j) measures similarity strength.

5) Scanning mch, if mch(i, j)>0, Mi and Mj are considered to have certain intersections in their experiences. Greater mch(i, j) means more prominent intersection between the two people. The details of experience intersections of the two resume elements can be expressed by its(i, j), which reflects potential relationships such as classmates, colleagues, fellow countrymen, and comrades among people reflected in the resumes.

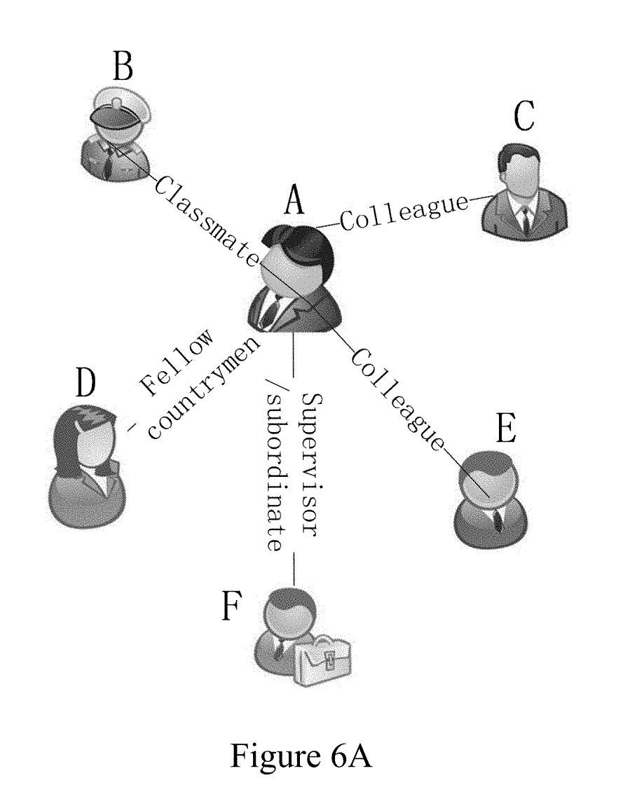

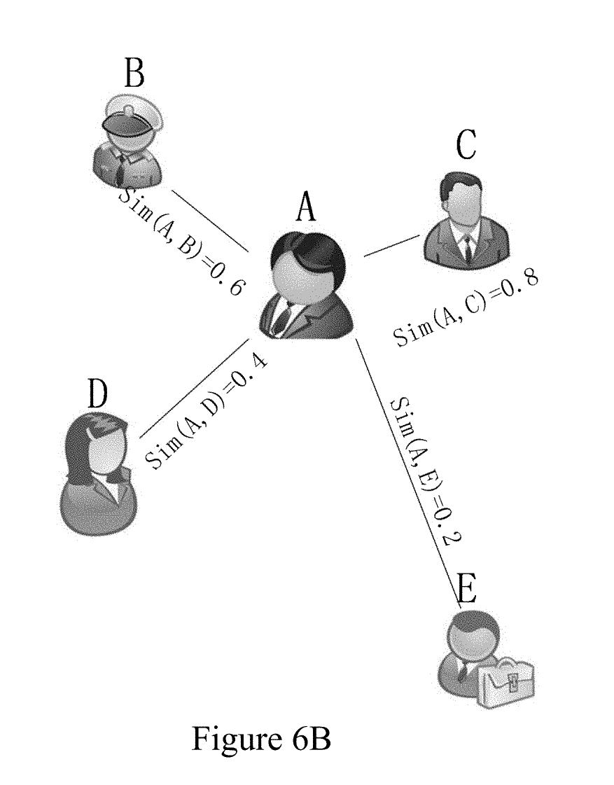

6) Repeating steps 4 and 5 until all resumes in M have been scanned and processed to give potential social relationships R among all resumes. Potential social relationships can be categorized in two types: one relates to growth trajectory similarity relationship based on the similarity matrix obtained sim, and the other is obtained through the experience intersection relationship based on matching matrix mch. FIGS. 6A and 6B are schematic diagrams showing the results of discovering potential relationships.

Among them, the resume element matching algorithm mentioned in step 3 takes Mi and Mj as input, and outputs matching mch(i, j) for Mi and Mj, err(i, j) which is composition difference Mi relative to Mj, and intersection its(i, j) between Mi and Mj. The method specifically includes the steps of:

3-1) Defining two counters Ct and Cr having initial values of 0. Ct is the number of element comparisons between Mi and Mj. Cr is the number of biographical elements that are common between Mi and Mj. A list of differences between the biographical elements is defined as err(i, j), whose elements are dissimilar resume elements between Mi and Mj. Resume intersection list table is define as its(i, j), whose elements are the common resume elements between Mi and Mj.

3-2) The basic resume elements (such as name, gender, nationality, place of birth and other basic information) Mi and Mj are scanned item by item, Ct is incremented by 1 for each item scanned. At the same time, for any element f, if f (Mi)=f (Mj), Cr is incremented by 1, and the element f is added to its(i, j). Otherwise, the element f is added to err(i, j). For example, if person i was born in Beijing, and person j born in Shanghai, when the resume element “place of birth” is scanned, f(Mi)=“Beijing”, f(Mj)=“Shanghai”.

3-3) The experience information tables in Mi and Mj are progressively scanned. For each line of experience segment, the location, organization, position and other factors in the experience are scanned. For each scanned element, Ct is incremented by 1. At the same time, for any element e, if e(Mi)=e(Mj), then Cr is incremented 1, and the element e is added to its(i, j). Otherwise, the element e for this experience segment is added to err(i, j).

3-4) Repeating steps 3 and 4 until the resume elements in Mi and Mj are all scanned and processed. The matching degree mch(i,j) is calculated according to the following formula

mch(i,j)=Cᵣ/Cₜ

5. The Organization Construction Module

The organization construction algorithm in this module innovatively extracts potential social relationships among groups from multiple resumes and reconstructs organizational hierarchy, to provide basis for subsequent visualization algorithms for organization chart. The method specifically includes the steps of:

1) A potential relationship matrix R in known resumes is output from the potential social relationship discovery module. R has a size n×n, wherein each element R11˜Rnn represents a potential social relationship among the corresponding pair of resumes. The matrix element Rij represents potential social relationship between resumes Mi and Mj.

2) The organization library is defined as V, which stores information about an organization and its members. The library has a list structure: <V1, V2 . . . , Vm>, in which each element Vi (i=1, 2 . . . m) represents an organization, m is the number of organizations. The elements in the library can be organized in a tree structure, wherein the root of the tree is “organization name”; the branch nodes are “membership information”. Specifically, elements in the library can have the following structure: <organization name, <member 1, position 1, incumbent or not >, <member 2, position 2, incumbent or not > . . . , <member m, functions m, incumbent or not >>.

3) Counter k is defined (initial value is zero).

4) Scanning all elements in R. If the resumes Mi and Mj represented by Rij include biographical intersection, then the element Rij as well as resume elements Mi, Mj are stored to Vk, while k is incremented by 1. Vk is stored in V, with Vk being an element of V.

5) Repeating steps 4, until all elements in R are scanned and processed. At this time, all the elements of V constitute the information for the required organization.

6. Biographical Information Visualization Module

The module is based on information visualization technology. It presents resume information in intuitive way to the users, to help them to view and to correctly understand resume data. The module contains three kinds of visualization algorithms: temporal and spatial biographic trajectory visualization algorithm, potential social network visualization algorithm, and organization visualization algorithm. The three algorithms can generate the following diagrams: personal growth charts, potential diagrams, and organizational charts.

6.1 Personal Growth Chart

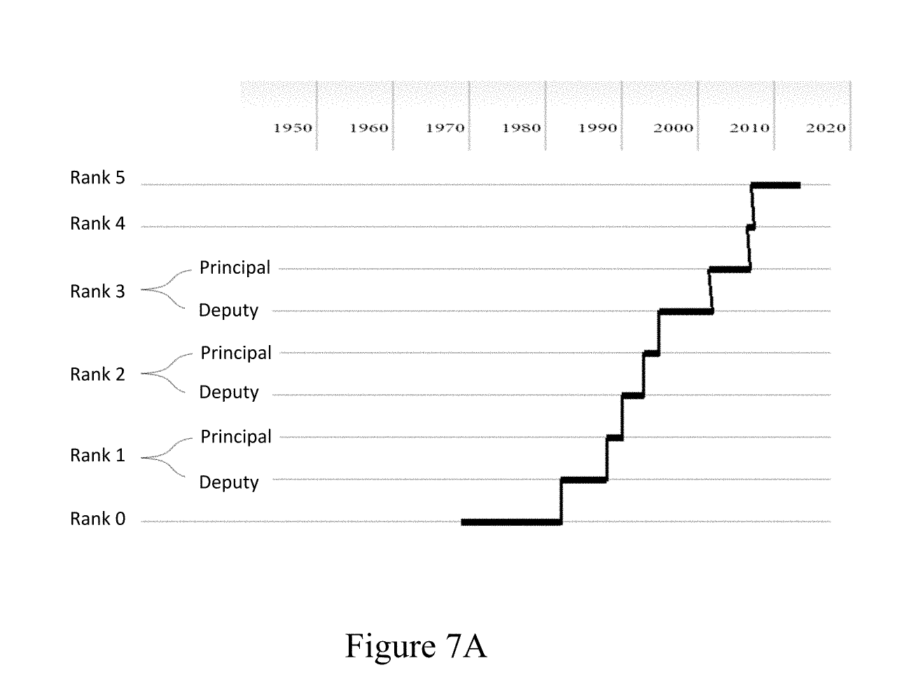

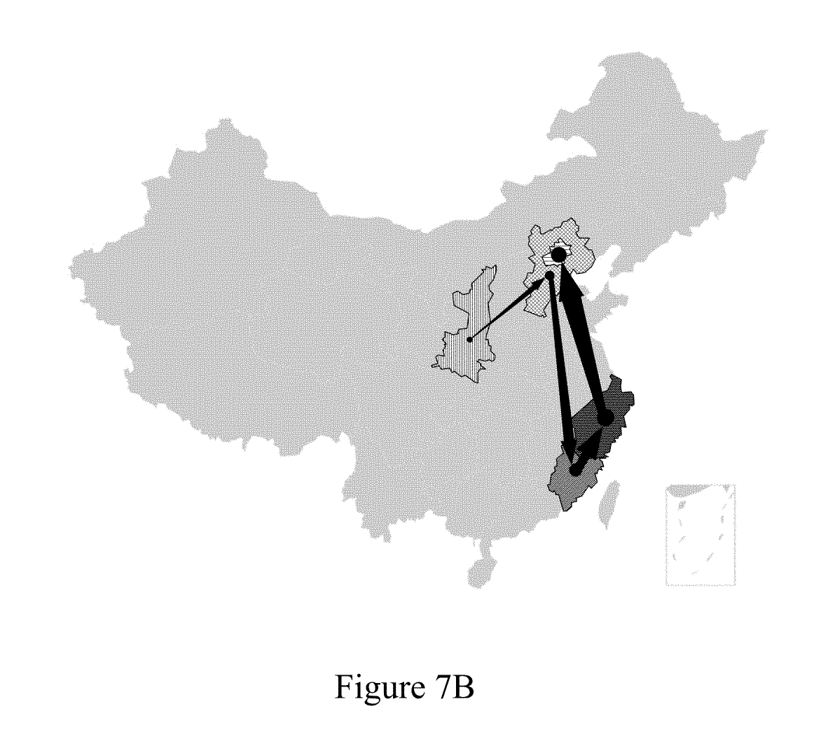

As shown in FIGS. 7A and 7B, the temporal and spatial personal growth trajectory diagrams are drawn by the visualization algorithms. The algorithm uses the concept of growth metaphors to generate temporal and spatial trajectory visualization diagrams, and can intuitively display otherwise abstract personal growth information. The algorithm can include following steps:

1) Defining visual axes for a temporal growth trajectory. The horizontal axis is time, expressed in “year” or “age”. The vertical axis is ranking value, representing “the quantized rank” (which can use official positions as example and can include “section level”, “department class”, “bureau level”, etc.; for researchers, “intern assistant”, “research assistant”, “research associate”, “research fellow”, and “academy member” etc.) in the growth trajectory sequence data.

2) Defining axes for spatial trajectory visualization. The horizontal axis is time, expressed in “year” or “age”. The vertical axis is spatial axis, using a two-dimensional map as the spatial reference system, representing “place” and “organization” in the spatial growth trajectory sequence data.

3) Defining the concept of visualization of sequence data growth trajectory. A growth trajectory sequence data is formed by a series of experience segments, with each segment representing the basic unit of the growth trajectory sequence data.

\textcircled{1} Visualization of temporal growth trajectory: experience segments can have constant widths, variable lengths, and color filled rectangular blocks to express visual metaphors. The horizontal position of the rectangular block corresponds with the timeline; its width represents time interval of the experience segment (the left end stands for “start time” and the right end stands for “end time”). The rectangular block's position along the longitudinal axis corresponds to the rank, that is, the “quantized rank” in this experience section. The times between the rectangular blocks are connected by vertical lines, forming a complete visualization expression of a temporal growth trajectory. Temporal growth trajectories of different resumes can be visually distinguished by different filled colors in the rectangular block.

\textcircled{2} Visualization of spatial growth trajectory: experience segments can be represented by circles filled with colors and having variable radii. The positions of the circles are projected to the spatial axes of a two dimensional map, representing “location” and “organization”. Arrows with filled colors and varying widths can connect the circles in chronological sequence, to form a complete visualization expression of a spatial growth trajectory. The arrow width can vary from starting point to the end point (the width can represent ranking level). Spatial growth trajectories of different resumes can be visually distinguished by different filled colors in the rectangular block.

4) Growth trajectory based on input biographical sequence data. In accordance with the definition of the steps 1 to 3 above, assign appropriate filled colors and conduct visual rendering to produce biographical space-time growth trajectories.

6.2 Potential Relationship Diagrams

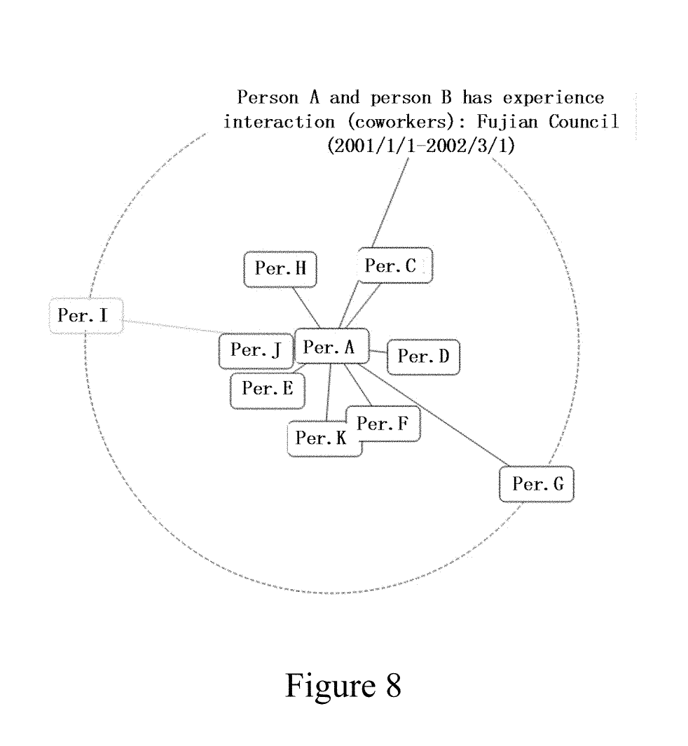

As shown in FIG. 8, the potential relationship diagram is drawn based on the potential social networking visualization algorithm. The algorithm uses the potential relationships discovered in resumes to construct a visual expression for a social network. The resulting potential relationship diagram can intuitively express originally abstract resume relationship data in a network graph fashion. The algorithm steps can include the following steps:

1) Defining visualization method for resumes. Resumes are represented with rounded rectangle as its visual metaphors. The interior of the rounded rectangle displays the basic biographical information with “name” in resume as the rectangle ID. Rectangles with different IDs represent different experiences.

2) Defining visualization method for potential relationships. The potential relationships discovered from the resumes are categorized to types by the discovery algorithms:

\textcircled{1} Similar growth trajectories. Rounded rectangles are connected by lines to represent a certain degree of similarity between resumes' growth trajectories. Similarity between biographical growth trajectories reflects the similarity between intersection experiences. For example, if person A and person B spend similar time durations from “department level” officials to “bureau-level” officials, the two individuals' growth trajectories are then similar. Segment length can characterize degree of similarity: the shorter segment (smaller distance between the two rectangles), the greater the similarity; and vice versa. The similarity between person A and person B can be characterized by the similarity matrix sim mentioned in discussing the potential social relation discovery module.

\textcircled{2} Resume elements having with intersections. Rounded rectangles connected by lines represent some degree of intersection between resumes. Element intersection reflects intersections in experiences between people, such as, classmates, fellow countrymen, coworkers, and so on.

3) Based on the input biographical XML data, and the results of data discovery, in accordance with the definitions in steps 1 and 2 above, visual rendering is performed to result in a potential relationship diagram (see FIG. 8).

6.3 Organization Chart

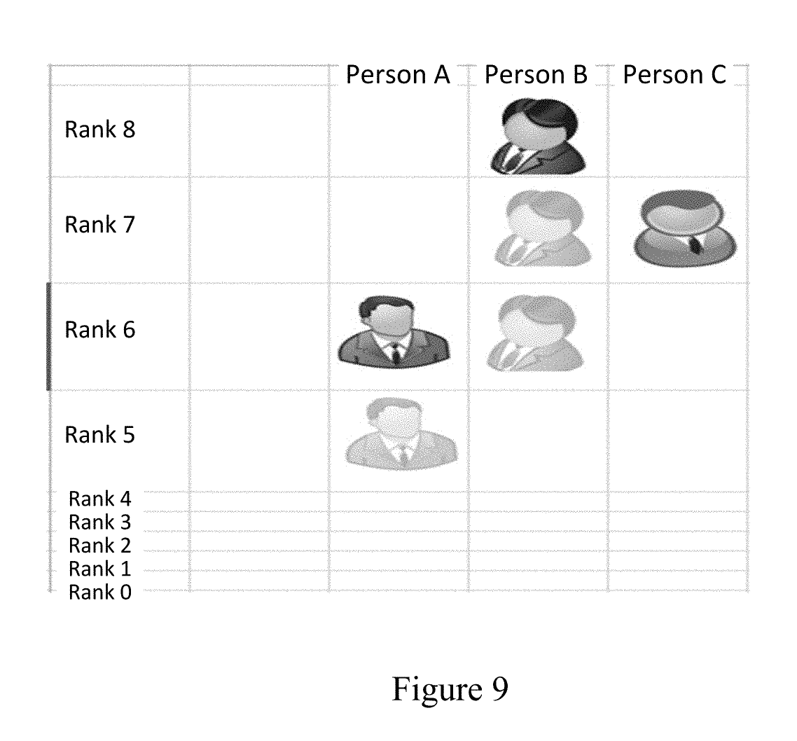

As shown in FIG. 9, the organization chart is drawn using organizations visualization algorithm. The algorithm extracts the work-institution intersection information between resumes, and converts it to the corresponding organization relationship of the intersecting organizations. This relationship is used to reconstruct tabulated organization chart and perform visualization. The algorithm can include the following steps:

1) Defining the header of the organizational chart. The horizontal axis is personnel, representing the institution's personnel. The vertical axis is job grade level, representing the institution's job ranks. The higher post ranks are on top; the lower ones in the bottom.

2) Defining the table elements in the organizational chart. The table elements are represented by personnel face images in their resumes. The row that the element is on is determined by the job title in the institution, the position in the column represents the personnel. The elements can have two states: \textcircled{1} active (personnel face image is in color), indicating that the person currently works in this institution; \textcircled{2} inactive state (personnel face image in gray color), indicating that the element is a historic position that a person held (for example, a former officer of the organization at the corresponding position, but now no longer holding the post).

3) For the input biographical XML data, as defined by the steps 1 and 2 above, performs visual rendering to obtain the organizational chart of the corresponding organization.

7. Resume Visual Analytics Module

The module applies interactive visual technology to visual analytics environment for biographical data. Based on the various discovery modules and visualization module discussed above, this module helps users understand the underlying patterns in the biographical data and significant number growth modes characterized in the resumes, thus providing in-depth knowledge. The module can specifically perform the following steps:

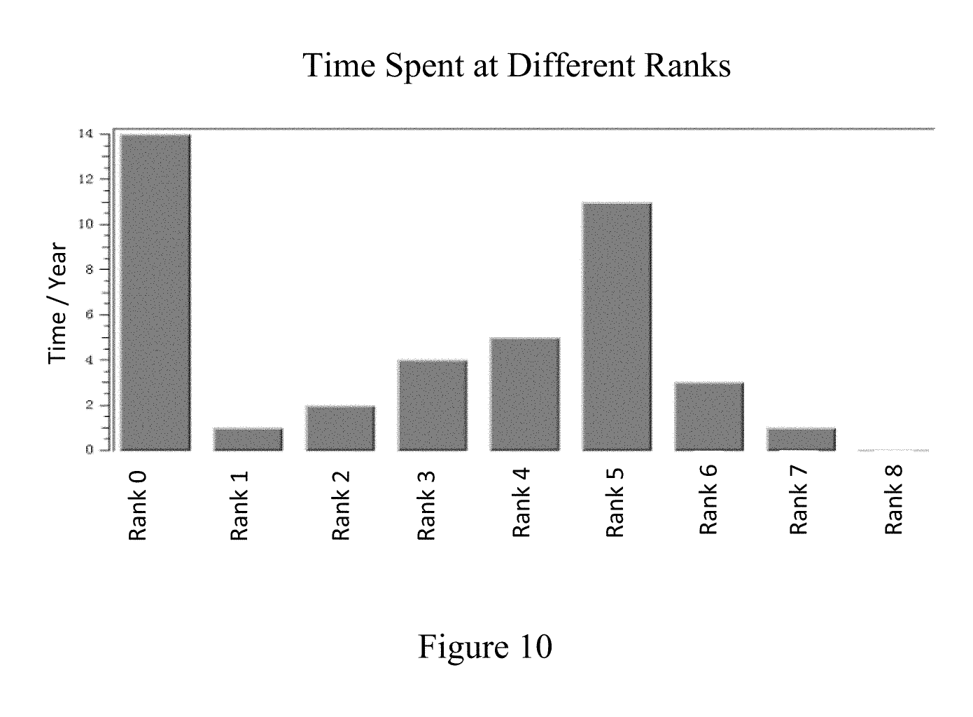

1) Statistics analysis of resume trajectory information. As shown in FIG. 10, based on the “quantized rank” in the sequence data of the growth trajectory, the statistical distribution of times that personnel spent at each job grade is provided (horizontal axis is “rank”, the vertical axis is “time”). This statistical distribution plot can convey a general pattern of personal growth to users.

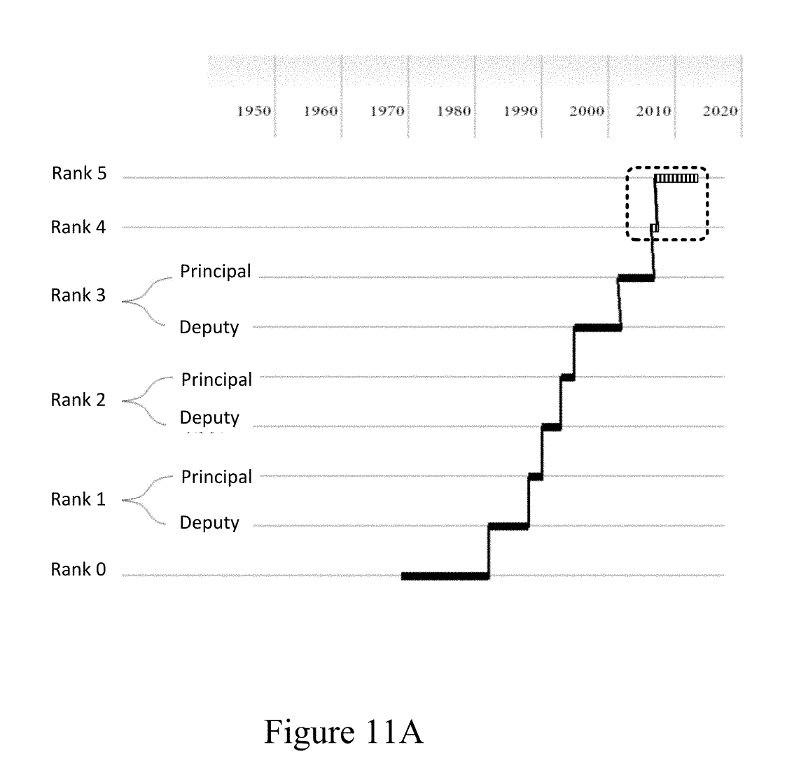

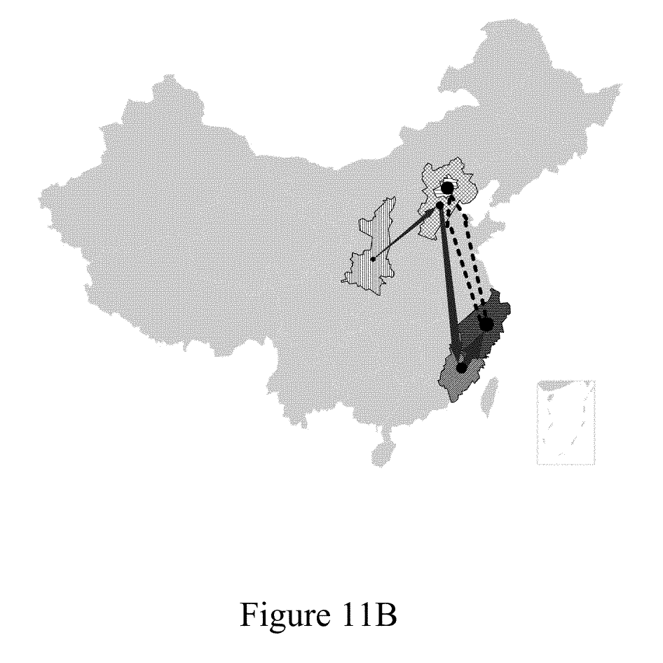

2) Resume space-time trajectory overlapping analysis. As shown in FIGS. 11A and 11B, the space-time growth trajectories based on resume can interactively provide relational analysis capabilities, for users to examine trajectory changes in time and space, which helps to identify space time patterns in growth trajectories. In addition, according to the existing space time pattern in the growth trajectory, future growth trend can be predicted, which is an important part of the interactive visual analytics.

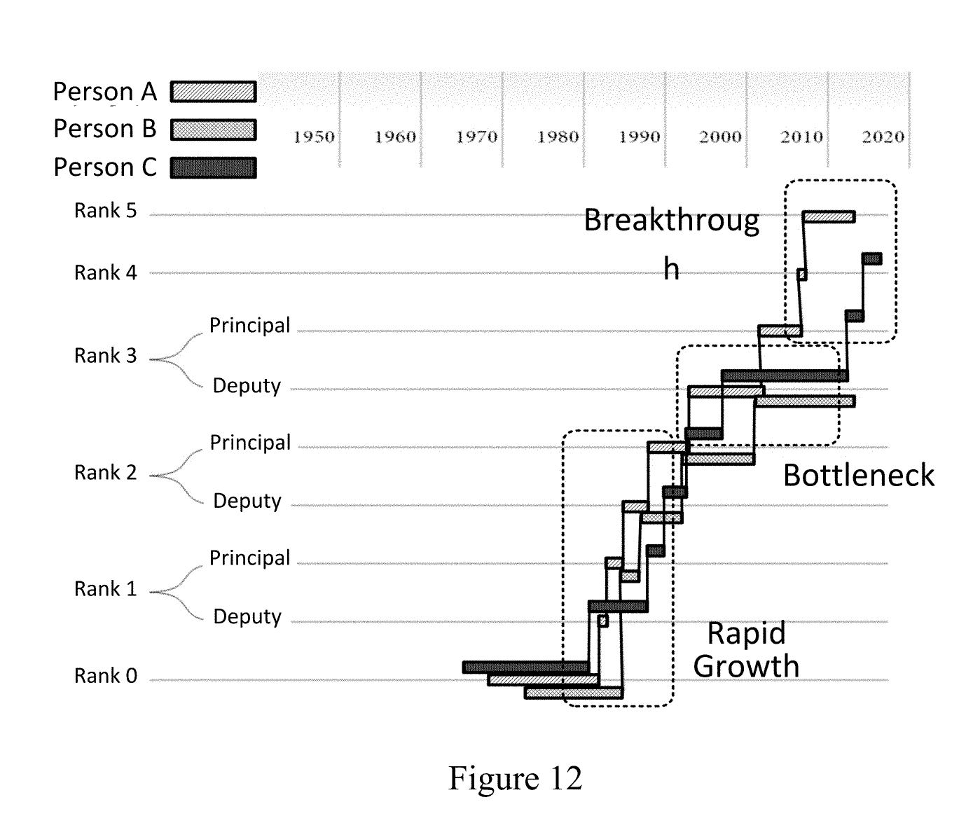

3) Visual analytics of resume space-time trajectory pattern. As shown in FIG. 12, the space-time diagram for growth trajectories, the user can identify different growth modes in growth trajectories by comparing multiple resumes, and to quickly find interesting trajectory categories. For example, a user can visually comprehend three stages in a person's growth experience from FIG. 12: rapid growth (the initial, faster career advancement), the bottleneck period (mid-career, promotion bottleneck), and breakthrough period (breaking the bottleneck with continued promotion at the end of career). For clarity reasons, up to 3 growth trajectories can be displayed at same time for comparative analysis. Different resumes can offset in time and space axes, without reducing visual accuracy while reducing blocking between different trajectories.

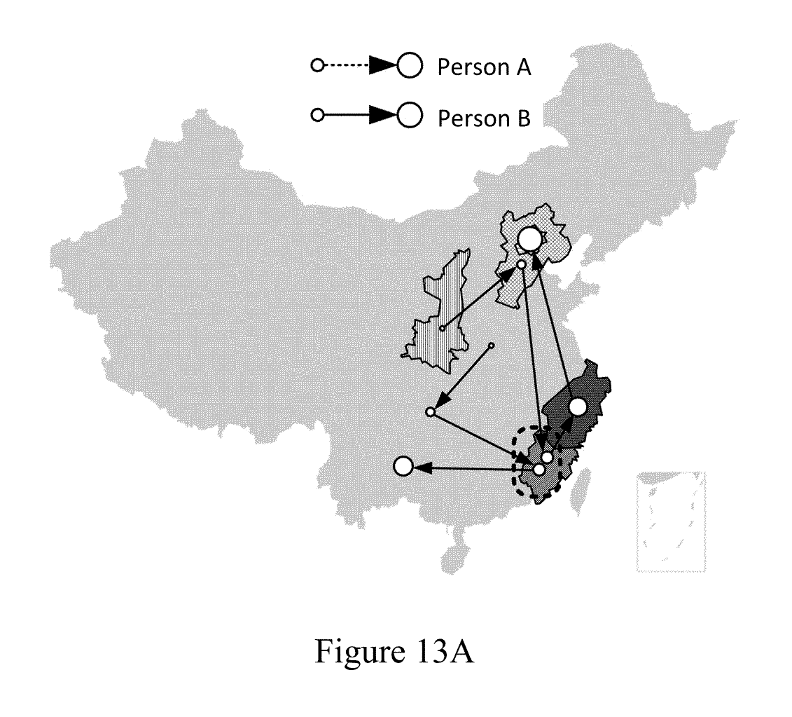

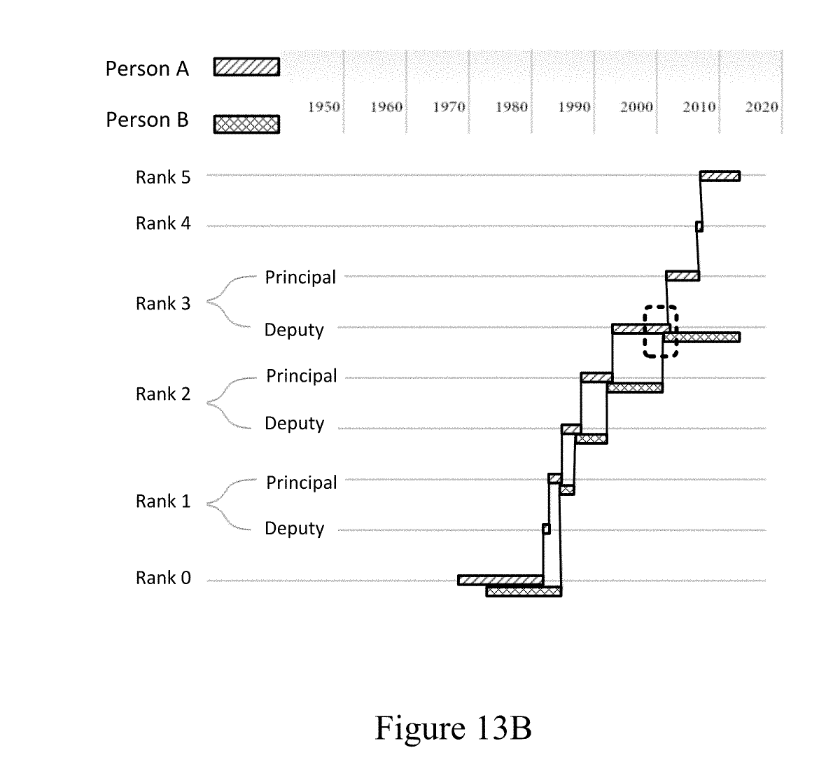

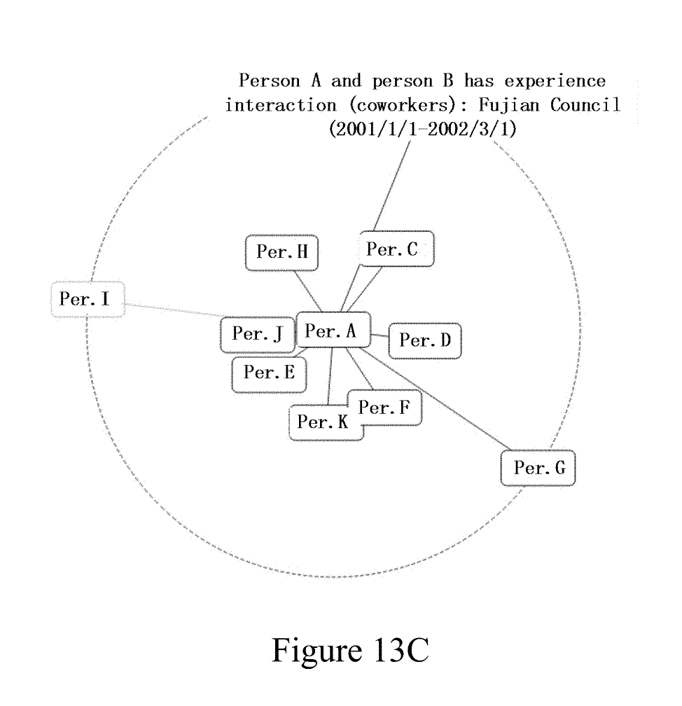

4) Visual analytics of resume social networks. As shown in FIG. 13, based on the potential relationship diagram in a group of resumes, users can selectively choose target resumes according to their own interests to view potential relationships and associated social network formed by the resumes. Meanwhile, interactive editing and query features can be provided based on the social network, to guide users to purposely examine important potential relationships.

5) Supporting interactive biographical data discovery. Based on various discovery modules and interactive mechanisms, users can further benefit from expert knowledge and cognitive ability in addition to the discoveries (such as, modifying datamining parameters, tagging resume categories, etc.). By iteratively amending and revising datamining results, users can gain deeper understanding of the potential knowledge inherent in the biographical data.

What is claimed is:

1. A biographical information visualization method for text resumes, comprising the steps of:
1) quantifying experiences in each text resume to obtain growth trajectory sequence data; and rendering visualization of the growth trajectory sequence data;
2) selecting multiple text resumes to conduct associative computation between their associated growth trajectory sequence data to obtain potential social relationships between the text resumes; and rendering visualization of a social network based on the potential social relationships; and
3) identifying a common organization in experiences in text resumes; constructing organization hierarchy for the organization based on the potential social relationships in the text resumes; and rendering visualization of the organization hierarchy for the organization.

2. The method of claim 1, further comprising:
converting an unstructured text resume to a structured text resume, including the steps of:
1) filtering format of the unstructured text resume to obtain a pure text version of the unstructured text resume;
2) parsing words and identifying proper names in the pure text version of the unstructured text resume; extracting biographical elements from the pure text version of the unstructured text resume to obtain structured text blocks comprising the biographical elements; and
3) formatting the structured text blocks comprising the biographical elements to obtain a structured text resume.

3. The method of claim 2, wherein the structured text resume includes: basic information and an experience information table, wherein the basic information includes names, gender, nationality, and place of birth, wherein the experience information table has a table structure having a table header comprising start time, end time, location, organization, and job functions fields for jobs.

4. The method of claim 3, wherein organization elements are extracted by keyword matching, comprising the steps:
1) creating an organization keyword dictionary comprising keywords and one or more auxiliary keywords corresponding to each keyword, wherein the auxiliary keywords includes an R type and a L type two;
2) recognizing a potential organization element using the keywords in the organization keyword dictionary; and
3) if the potential organization element does not include an R-type auxiliary keyword on the right side and does not include a L-type auxiliary keyword on the left side, determining the potential organization element as a correct organization element, wherein if the potential organization element includes an R-type auxiliary keyword on the right side and includes a L-type auxiliary keyword on the left side, the potential organization element is considered not a organization element.

5. The method of claim 3, wherein the growth trajectory sequence data is obtained by:
1) sequencing experience records in the experience information table in an ascending chronologically order;
2) extracting location, organization, and job function fields from each of the experience records; and match each of the location, organization, and job function fields to corresponding fields in a rank quantization library to obtain quantized ranks for the job functions; and
3) producing the growth trajectory sequence data by a chronological sequence of quantized ranks.

6. The method of claim 1, wherein the growth trajectory sequence data includes six tuples: <start time, end time, location, organization, job function, quantized rank>.

7. The method of claim 1, wherein the step of obtaining potential social relationships comprises:
1) selecting growth trajectory sequence data from n number of resumes; calculating similarity sim(i, j) between growth trajectory sequence data of two resumes Mi and Mj to obtain a similarity matrix sim;
2) if sim(i, j)>s0, determining Mi and Mj having similarity in their growth trajectories, wherein s0 is a similarity threshold;
3) calculating degree of matching mch(i, j) between growth trajectory sequence data of two resumes Mi and Mj; and storing intersection between growth trajectory sequence data of two resumes Mi and Mj in an experience intersection set its(i, j); and
4) determining whether Mi and Mj has intersection based on mch(i, j); if there is, determining a potential social relationship between Mi and Mj according to the experience intersection set its(i, j) and determining closeness between Mi and Mj based on magnitude of mch(i, j).

8. The method of claim 7, wherein step 3) further comprises:
1) defining two counters Ct and Cr having values of 0, Ct is number of element comparisons between Mi and Mj, wherein Cr is number of biographical elements that are common between Mi and Mj; and defining err(i, j) to store a list of differences between the biographical elements;
2) scanning each element in the basic information in Mi and Mj; incrementing Ct by 1; for each scanned element f that is common in Mi and Mj, incrementing Cr by 1 and storing the element fin its(i, j); storing the element that is not common in Mi and Mj in err(i, j).
3) for each row of the experience information table in Mi and Mj, scanning the experience, location, organization, and job function fields in each row, incrementing Ct by 1; for each field e that has same value in the Mi and Mj, incrementing Cr by 1, and storing the element fin its(i, j); otherwise, storing the element in err(i, j); and
4) calculating mch(i, j) according to the formula mch(i, j)=Cᵣ/Cₜ.

9. The method of claim 1, wherein step 3) further comprises:
1) recording the potential social relationships in a matrix R having matrix elements Rij representing potential social relationships between Mi and Mj;
2) establishing an organization library V to store information about organizations and their members, wherein the library elements are organized in a tree structure: the root of the tree stores the organization name and the branch nodes of the tree store membership information;
3) scanning the matrix R; if Rij indicates that Mi and Mj have intersection in their organizations, storing the associated common organization in Mi and Mj in the organization library V; and
4) rendering visualization of the organization hierarchy using all elements in the tree structure in the organization library V.

10. The method of claim 1, further comprising:
1) identifying growth modes in the growth trajectory sequence data in temporal and spatial dimensions, comprising the steps of:
2) defining temporal growth types and spatial growth types, wherein the temporal growth modes are characterized by time spans and quantized ranks in a sequence of job functions, wherein the spatial growth modes are characterized by sequential locations of the organizations; and
3) categorizing the growth trajectory sequence data using machine learning to obtain machine learning classifiers to tag the growth trajectory sequence data.

11. A visual analytics system for text resumes, comprising:
1) a personal growth experience quantization module configured to quantify experiences in each text resume to obtain growth trajectory sequence data; and rendering visualization of the growth trajectory sequence data;
2) a social relationship discovery module configured to select multiple text resumes to conduct associative computation between their associated growth trajectory sequence data to obtain potential social relationships between the text resumes;
3) an organizations construction module configured to identify a common organization in experiences in text resumes; constructing organization hierarchy for the organization based on the potential social relationships in the text resumes; and
4) a biographical information visualization module configured to render visualization of the growth trajectory sequence data, the social network based on the potential social relationships, and the organization hierarchy for the organization.

12. The visual analytics system of claim 11, further comprising:
1) a text resume preprocessing module configured to extract biographical elements from unstructured text resume to obtain structured biographical elements; and
2) a personal growth mode discovery module configured to analyze the growth trajectory sequence data in temporal and spatial dimensions to obtain temporal growth modes and spatial growth modes.
